(19) United States
(12) Patent Application Publication
(10) Pub. No.: US 2025/0178661 A1
(43) Pub. Date: Jun. 5, 2025

(54) STEERING SYSTEM

(71) Applicant: ZF AUTOMOTIVE GERMANY GMBH, Alfdorf (DE)

(72) Inventors: Ian BLÄSER, Bochum (DE); Jacopo Francesco ZINI, Alfdorf (DE); Metin SÖNMEZ, Erkelenz (DE)

(21) Appl. No.: 18/966,266

(22) Filed: Dec. 3, 2024

(30) Foreign Application Priority Data
Dec. 4, 2023 (DE) 10 2023 212 187.5

(51) Int. Cl. B62D 5/00; B62D 5/04; B62D 15/02

(52) U.S. Cl. CPC B62D 5/001; B62D 5/0406; B62D 5/0481; B62D 15/0235

(57) ABSTRACT

A steering system (10) for a vehicle is disclosed, in particular a steer-by-wire steering system, having a linearly displaceable rack (12), a drive portion of the rack (12), via which the rack (12) is moved during steering, and having a detection device (16), separate from the drive portion, for detecting a position of the rack (12), wherein the detection device (16) comprises a rotatable pinion (20) driven by the rack (12), which pinion has a toothing (21) in engagement with a toothing on the rack (12), and a rotor (32) which is in rotationally fixed engagement with the pinion (20), wherein the rotor (32) comprises at least one portion (66) which is flexible in the radial direction.

### TECHNICAL FIELD

The invention relates to a steering system for a vehicle, in particular a steer-by-wire steering system.

### BACKGROUND

In such systems, a drive motor is provided for adjusting a steering angle on the wheels of the vehicle, said drive motor displacing a rack.

In steer-by-wire steering systems, there is no mechanical connection between the steering wheel and the rack. The position of the steering wheel is electronically detected and a corresponding displacement of the rack is achieved by means of a drive motor.

In order to determine the steering angle, a detection device is provided with sensors for indirectly detecting the steering angle on the basis of a rotational position of a pinion which is interlocked with the rack and can be rotated by the rack. These sensors, together with the pinion, are usually housed in a housing, also known as a “pinion tower”, in current systems. A rotor is usually connected to the pinion in a rotationally fixed manner, wherein the sensors are able to detect the rotational position of the pinion directly or indirectly based on the rotor position.

In order to connect the rotor to the pinion, the rotor is placed axially on the pinion, the rotor in the known systems having to be aligned relatively precisely with respect to the pinion. The assembly of the detection device is therefore very complicated. Blind assembly, in which the pinion and the rotor are not visible to a technician at the moment of assembly, is thus virtually impossible.

It is therefore an object of the present invention to provide a steering system with a detection device for detecting a position of the rack, which can be mounted in a particularly simple manner.

### SUMMARY

This object is achieved according to the invention by a steering system for a vehicle, in particular a steer-by-wire steering system, having a linearly displaceable rack, a drive portion of the rack, via which the rack is moved during steering, and having a detection device, which is separate from the drive portion, for detecting a position of the rack, wherein the detection device comprises a rotatable pinion, which is driven by the rack and has a toothing which is in engagement with a toothing on the rack, and a rotor, which is in non-rotatable engagement with the pinion, wherein the rotor comprises at least one portion which is flexible in the radial direction.

The flexible portion of the rotor results in advantages in the assembly of the detection device, in particular in the assembly of the rotor on the pinion. Specifically, the rotor does not have to be pushed exactly coaxially onto the pinion during assembly. If the rotor is pushed radially offset onto the pinion, the elastic deformation of the radially flexible portion which occurs in this case makes it possible for the rotor to be self-aligned on the pinion. In addition, the flexibility permits a certain tolerance compensation in the axial direction, for example with regard to the diameter of the pinion.

The rotor is radially flexible, in particular in a region in which the rotor overlaps axially with the pinion.

The pinion is preferably a metal part.

The detection device preferably comprises at least one magnetic sensor which is set up to detect a rotational position of the rotor and to determine a position of the rack on the basis of said rotational position.

In particular, a drive motor is coupled to the drive portion of the rack, which drive motor actively drives the rack.

The pinion is moved passively by the rack.

The pinion has, for example, a further toothing which is axially spaced from the toothing which is in engagement with the rack, the rotor being in engagement with the further toothing. In this way, the rotor is reliably in non-rotatable engagement with the pinion, so that a rotation of the pinion during a displacement of the rack results in a rotation of the rotor.

For example, the rotor has a sleeve-shaped portion, on the inside of which axially extending ribs are present, which are in engagement with the toothing of the pinion, wherein the ribs taper towards the pinion. In other words, the effective inner diameter of the rotor tapers in the axial direction towards the upper side of the sensor, i.e. in the direction away from the pinion. The tapering of the ribs towards the lower end or the larger effective internal diameter at the lower end of the rotor makes it possible for the two components to slide more easily into one another. In particular, a certain tolerance compensation can take place. Furthermore, the shape of the ribs, which expand correspondingly in the direction away from the pinion, i.e. in the axial direction upwards, results in an increasing clamping force when the components are joined together.

The effective inner diameter of the rotor is measured, for example, between the ribs, inter alia, from rib tip to rib tip.

The effective internal diameter is, for example, between 9 and 12 mm. In particular, the internal diameter at the lower end directed towards the pinion is up to 0.5 mm, preferably 0.3 mm, smaller than at the upper end directed away from the pinion.

At the lower end directed towards the pinion, the ribs have, for example, a radius of 0.5 to 3 mm.

According to an embodiment, the rotor is made of plastic and surrounded in the region of the radially flexible portion by a separate stiffening element, which is in particular a metal ring. Such a separate stiffening element ensures that the rotor is reliably held in engagement with the pinion in the event of temperature and/or humidity fluctuations and that slip or hysteresis between the pinion and the rotor are avoided.

The stiffening element is, for example, a metal ring.

For example, the stiffening element is an element which is separate from the rotor and which is held on the rotor in a form-fitting manner, for example is latched to the rotor. However, it is also conceivable for the stiffening element to be integrated in the rotor. For example, the stiffening element can be a metal ring, which is encapsulated with the plastic forming the rotor.

The further toothing of the pinion is preferably beveled conically at its end directed towards the rotor. This also contributes to a possible self-alignment of the sensor module on the pinion.

According to an alternative embodiment, cavities may be present in the flexible portion of the rotor. The cavities reduce the stiffness of the rotor in the flexible portion, whereby the flexibility is achieved. As a result, the rotor can deform elastically in a manner similar to a spring.

In this case, the rotor is preferably an injection-molded plastic part, as a result of which the cavities can be realized simply during the manufacture of the rotor.

For example, the rotor has a circumferential, radially projecting collar which has multiple openings which pass through in the axial direction and form the cavities. Since the openings are formed in a radially projecting collar, the rotor can be produced in an injection mold without using a slide, i.e. the production of the rotor is particularly simple and cost-effective.

The openings are preferably elongated holes, which are in particular curved. Thus, the openings are adapted to the contour of the rotor, which is advantageous with regard to the flexibility of the rotor.

In a further embodiment, the flexible portion is formed by at least one slot in the rotor extending in the axial direction. Due to the axially extending slot, the stiffness of the rotor in the flexible portion is reduced, which likewise results in a sufficiently high flexibility of the rotor or an improvement in the spring behavior. In particular, the portions of the rotor separated by slots act like spring arms.

The at least one slot extending in the axial direction is not completely continuous, so that the rotor has, in addition to the flexible portion, also a portion with increased stiffness in comparison with the flexible portion. If a plurality of slots are present, the rotor can also be produced as a one-piece component, which results in simple handling during assembly.

The rotor can comprise at least one metallic component or can be formed from a metallic material. The metallic component or the metallic material ensure that the rotor remains reliably in engagement with the pinion even in the event of temperature and/or atmospheric humidity fluctuations, in particular since the temperature coefficients of the metallic component or of the metallic material, in comparison with the temperature coefficient of a plastic material, coincide significantly better with the temperature coefficient of the pinion, which is usually likewise produced from a metallic material. In this way, slippage or hysteresis between the pinion and the rotor is avoided. In other words, the connection between the rotor and the pinion is designed as free of play as possible.

The metallic component can be made of spring steel or the metallic material can be spring steel. In this way, even when a metallic material is used, a sufficiently great flexibility of the flexible portion is achieved.

According to an embodiment, the rotor comprises a plastic component which is firmly connected to the metallic component, wherein a geometry for the rotationally fixed engagement of the rotor with the pinion is provided in the plastic component. The plastic component and the metallic component are in particular not detachable in a destruction-free manner. Such a rotor has the advantage that the metallic component ensures sufficient dimensional stability in the event of temperature fluctuations, while in the plastic component the geometry for the rotationally fixed engagement of the rotor with the pinion can be realized with high dimensional accuracy.

The metallic component is, for example, encapsulated by injection molding with plastic. The overmolding represents the plastic component. The connection of the metallic component to the plastic component thus takes place in a particularly simple manner during the production of the plastic component.

In addition to the geometry for the rotationally fixed engagement of the rotor with the pinion, an additional toothing can be realized in the plastic component, which is in particular an external toothing on the rotor. The external toothing serves to drive gears, the position of which can be detected by magnetic sensors of the detection device.

Both the metallic component and the plastic component can have a slot. The slot in the metallic component is preferably arranged congruent with the slot in the plastic component. In this way, the flexible portion is prevented from being stiffened by the metallic component or the plastic component.

### BRIEF DESCRIPTION OF THE DRAWINGS

Further advantages and features of the invention will be apparent from the following description and the accompanying drawings which are referenced. In particular, in the figures:

FIG. 1 shows a steering system according to the invention,

FIG. 2 shows a sensor module of the steering system in a view from below,

FIG. 3 shows a housing cover of the sensor module,

FIG. 4 shows a sectional view of the sensor module,

FIG. 5 shows a further sectional view of the sensor module,

FIG. 6 shows an exploded view of a subassembly of the steering system,

FIG. 7 shows a rotor of the steering system held on a housing cover,

FIG. 8 shows the rotor in a sectional view,

FIG. 9 shows the housing cover of the sensor module in a view from below,

FIG. 10 shows a first state during mounting of the sensor module,

FIG. 11 shows a further state during mounting of the sensor module.

FIG. 12 shows a further state during mounting of the sensor module,

FIG. 13 shows the sensor module in an end position,

FIG. 14 shows a pinion with a rotor according to an alternative embodiment in an exploded view,

FIG. 15 shows a rotationally fixed connection of the rotor of FIG. 14 to the pinion,

FIG. 16 shows the rotor from FIG. 14 inserted onto the pinion,

FIG. 17 shows a pinion with a rotor according to a further alternative embodiment in an exploded view,

FIG. 18 shows a rotationally fixed connection of the rotor of FIG. 17 to the pinion, and

FIG. 19 shows a rotor according to a further embodiment.

### DESCRIPTION

FIG. 1 shows a steering system 10 according to the invention, which is a steer-by-wire steering system.

The steering system 10 comprises a linearly displaceable rack 12. The rack 12 has a drive portion via which the rack 12 is moved during steering. The drive portion is not shown in the figures for the sake of simplicity.

The rack 12 is accommodated in a rack housing 14.

By displacing the rack 12, a steering angle on the wheels of a vehicle can be adjusted.

For the displacement of the rack 12, a drive motor is provided which is not shown in the figures for the sake of simplicity. The drive motor is coupled in particular to the drive portion of the rack 12. Such drive mechanisms are sufficiently known from the prior art.

In such steering systems 10, it is desirable to be able to determine a currently present steering angle at any time. This ensures that an electronically detected steering wheel position is always correctly translated into a steering angle.

For this purpose, the steering system comprises a detection device 16 for detecting the current position of the rack 12.

The detection device 16 is separated from the drive portion. In other words, the detection device 16 is spaced apart from the drive portion in the direction along the rack 12.

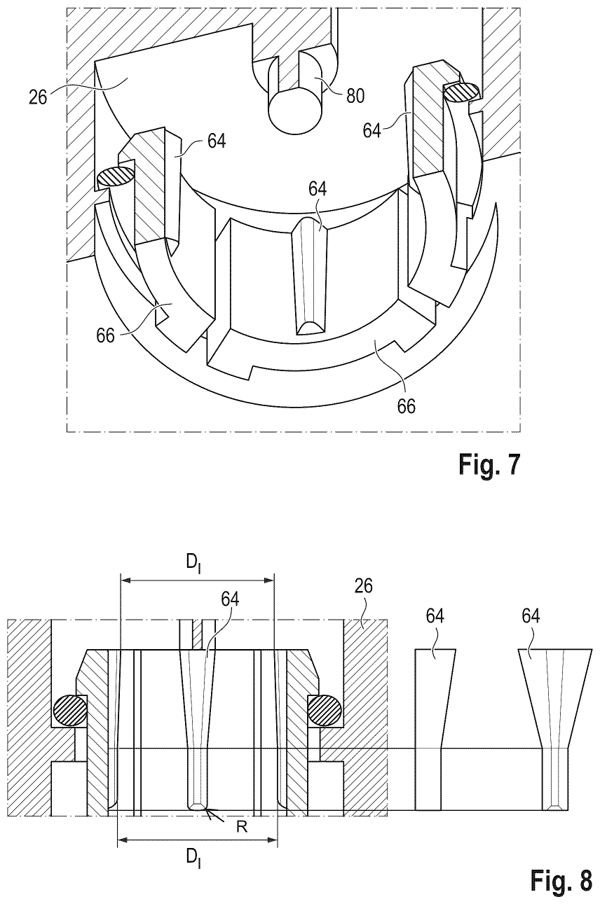

The detection device 16 comprises a housing 18 in which a rotatable pinion 20 is accommodated. The pinion 20 is visible in FIG. 6.

The housing 18 can be formed in one piece with the rack housing 14 or connected to it in another way.

The pinion 20 has a toothing 21 which is in engagement with the rack 12.

Due to the interlocked engagement, a linear displacement of the rack 12 causes a rotation of the pinion 20.

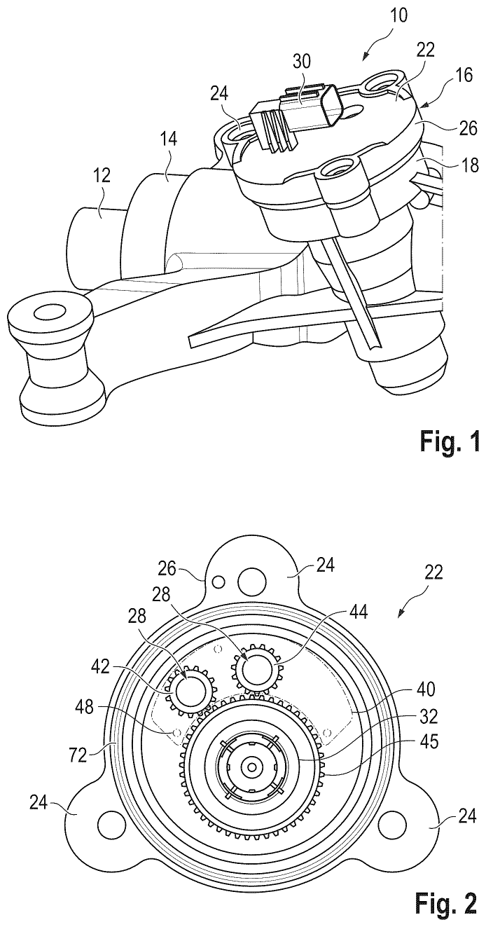

The detection device 16 further comprises a sensor module 22, which is illustrated in FIG. 2. In FIG. 1, only a housing cover 26 of the sensor module 22 is visible.

The sensor module 22 is placed on the housing 18 and fastened thereto. In particular, the sensor module 22 is screwed to the housing 18, as can be seen from the screw lugs 24 present on the housing cover 26.

As an alternative to the screw lugs 24, a clamping connection between the housing cover 26 and the housing 18 is conceivable. Specifically, it is conceivable that the housing cover 26 is fastened to the housing 18 by means of clamps.

In addition to the housing cover 26, the sensor module 22 comprises two magnetic sensors 28, a plug connector 30 (see FIG. 1) for the electrical connection of the at least one magnetic sensor 28 and a rotor 32 which is in non-rotatable engagement with the pinion 20.

The angle of rotation signals of the two magnetic sensors 28 can be calculated to give an absolute position signal, i.e. a clear signal over the entire travel of the rack 12.

In addition, the sensor module 22 can comprise a rotary counter which is not shown in the figures for the sake of simplicity.

As can be seen from FIGS. 1, 3 and 4, the plug connector 30 is integrally formed in the housing cover 26.

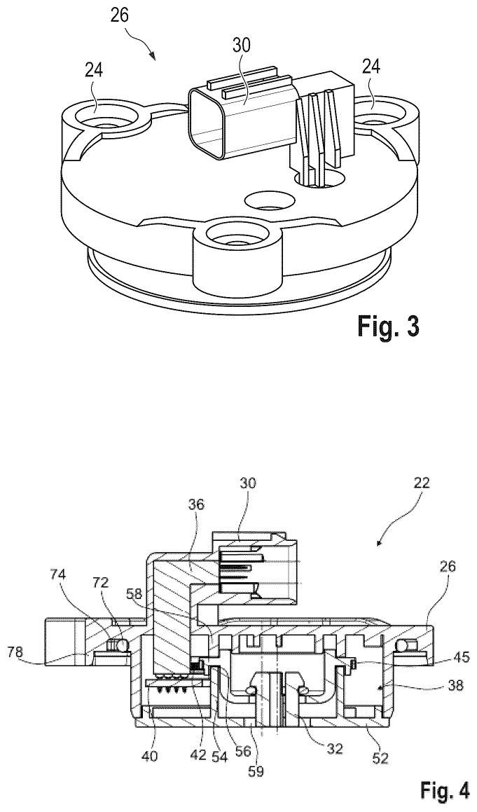

In concrete terms, an electrically conductive element 36 (see FIG. 4), which also comprises the connection pins of the plug connector 30, is cast into the housing cover 26, in other words, it is overmolded with the plastic forming the housing cover 26.

The other components of the sensor module 22 are arranged in a receiving space 38 formed in the housing cover 26, as can be seen in FIGS. 2 and 4.

In particular, the rotor 32, a printed circuit board 40 and two gears 42, 44 are arranged in the receiving space 38.

The rotor 32 is in interlocked engagement with the gears 42, 44, so that the gears 42, 44 likewise rotate when the rotor 32 is rotated. The external toothing 45 provided for this purpose on the rotor 32 can be seen in FIGS. 2, 4 and 5.

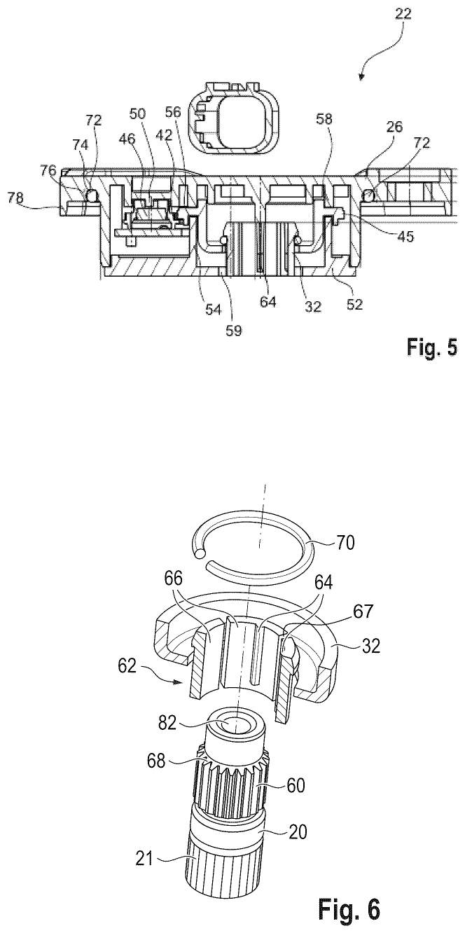

A magnet 46 is arranged on each gear 42, 44 (see FIG. 5).

The rotational position of the gears 42, 44 can be determined in a known manner by means of the magnetic sensors 28. A position of the rack 12 and thus the steering angle of the vehicle wheels can be determined on the basis of the rotational position of the gears 42, 44. Specifically, the magnetic sensors 28 determine a rotational position of the gears 42, 44.

The rotary counter which may be present determines a number of revolutions of the gears 42, 44.

In an alternative embodiment, which is not shown for the sake of simplicity, it is conceivable that one of the gears 42, 44 is omitted and instead a magnetic sensor is used which detects the angle of rotation and the number of revolutions only via the remaining gear and its magnets, from which the absolute position of the rack can be determined.

In a further alternative embodiment, which is likewise not shown for the sake of simplicity, it is conceivable that both gears 42, 44 are omitted and instead a magnet is fixed to the rotor 32. In this case, a magnetic sensor is used which is set up to detect the angle of rotation and the number of revolutions of the magnet, as a result of which the absolute position of the rack 12 can be determined.

In the two above-mentioned embodiments, the magnetic sensors 28 and/or the rotary counter can be designed as an integrated circuit in a common package on the printed circuit board 40.

The electrical contacting of the printed circuit board 40 is effected by means of contact pins on the electrically conductive element 36 which project through the printed circuit board 40 (see FIG. 4).

The mechanical attachment of the printed circuit board 40 to the housing cover 26 is effected, for example, by means of plastic pins (not visible in the figures) which are formed integrally in the housing cover 26 and which project through holes 48 (see FIG. 2) in the printed circuit board 40 and which are melted at their free ends during assembly, for example by hot caulking, as a result of which the plastic pins connect positively to the printed circuit board 40 and hold the latter on the housing cover 26.

Alternatively, the printed circuit board 40 can be screwed to the housing cover 26.

The printed circuit board 40 also holds the gears 42, 44 on the housing cover 26, as can be seen in the sectional view in FIG. 5.

Specifically, the gears 42, 44 lie on the printed circuit board 40.

In addition, alignment elements 50 (see FIG. 5) are provided on the housing cover 26, which align the gears 42, 44 along an axis of rotation and thus ensure that the gears 42, 44 are in interlocked engagement with the outer toothing 45 of the rotor 32.

The receiving space 38 of the housing cover 26 is closed on the side directed towards the pinion 20 by an intermediate cover 52.

The rotor 32 is held on the sensor module 22 by the intermediate cover 52.

For positioning the rotor 32, an annular or cylindrical projection 54 is provided on the intermediate cover 52 and projects in the direction of the housing cover 26, on which projection the rotor 32 rests. The projection 54 projects in particular into a corresponding slot 56 on the rotor 32, so that the rotor 32 is aligned radially.

A further annular or cylindrical projection 58 can additionally be provided on the housing cover 26, on which the rotor 32 is likewise radially aligned.

The rotor 32 is held axially between the projections 54, 58.

Thus, the position of the rotor 32 is precisely defined by the projections 54, 58.

The intermediate cover 52 is fastened to the housing cover 26, for example by means of plastic welding. Alternatively, a latching is conceivable.

In the intermediate cover 52 there is an opening 59 through which the rotor 32 is accessible, so that a connection between the rotor 32 and the pinion 20 is possible.

In the assembled state, the rotor 32 is non-rotatably mounted on the pinion 20, as is illustrated in the exploded view in FIG. 6. The external toothing 45 of the rotor 32 is not shown in FIG. 6 for the sake of simplicity.

For the rotationally fixed connection of the rotor 32 to the pinion 20, the pinion 20 has a further toothing 60 which is axially spaced from the toothing which is in engagement with the rack 12, the rotor 32 being in engagement with the further toothing 60.

Specifically, the rotor 32 has a sleeve-shaped portion 62, on the inner side of which there are axially extending ribs 64, which come into engagement with the toothing 60 of the pinion 20 during assembly. The ribs 64 thus form a geometry for the rotationally fixed engagement of the rotor 32 with the pinion 20.

The ribs 64 taper towards the pinion 20, as can be seen in FIGS. 7 and 8. The tapering preferably lies only in a partial portion of the ribs 64, as is schematically illustrated in FIG. 8. In particular, the tapering shown in the schematic view in FIG. 8 is exaggerated for better illustration, the schematically shown rib 64 being shown both in a side view and in a top view.

The partial portion in which the tapering takes place is directed in particular away from the pinion 20.

Thus, a larger effective internal diameter DI results at the end of the rotor 32 directed towards the pinion 20 than at the end directed away from the pinion 20. At the end of the rotor 32 directed towards the pinion 20, the internal diameter DI is, for example, 10.6 mm, and at the end directed away from the pinion 20, it is 10.3 mm, for example.

In FIG. 8, the effective inner radius DI is shown at two points for illustration.

The radius R of the ribs 64 at the lower end directed towards the pinion 20 is, for example, between 0.5 and 2 mm.

In addition, the rotor 32 has radially flexible portions 66 at least in the region in which the rotor 32 axially overlaps the pinion 20. As a result, the sleeve-shaped portion 62 can expand to a certain extent during assembly.

The radially flexible portions 66 are realized in the embodiment according to FIG. 6 by continuous slots 67 in the sleeve-shaped portion 62. In this manner, the individual portions 66 act like spring arms.

The further toothing 60 of the pinion 20 is a conical bevel 68 at its end directed towards the rotor 32, which bevel likewise serves to simplify the assembly. In particular, the conical bevel 68 forms an insertion bevel.

In the region of the radially flexible portions 66, the rotor 32 is surrounded by a stiffening element 70, for example a slotted ring.

The stiffening element 70 is made of a material which has a lower coefficient of thermal expansion than the material from which the rotor 32 is made. For example, the rotor 32 is a plastic injection molded part and the stiffening element 70 is made of metal, in particular a metal ring.

The stiffening element 70 limits a widening of the rotor 32 in the region of the radially flexible portions 66, in particular in the event of temperature and/or humidity fluctuations, so that reliable engagement with the pinion 20 is ensured.

As can be seen in FIG. 6, the stiffening element 70 is held on the rotor 32 in a form-fitting manner, in particular is latched to the latter.

A seal 72 is provided for sealing the sensor module 22 with respect to the housing 18.

The seal 72 is arranged axially between the housing cover 26 and the housing 18.

Specifically, a groove 74 is formed on the housing cover 26, in which groove the seal 72 is inserted.

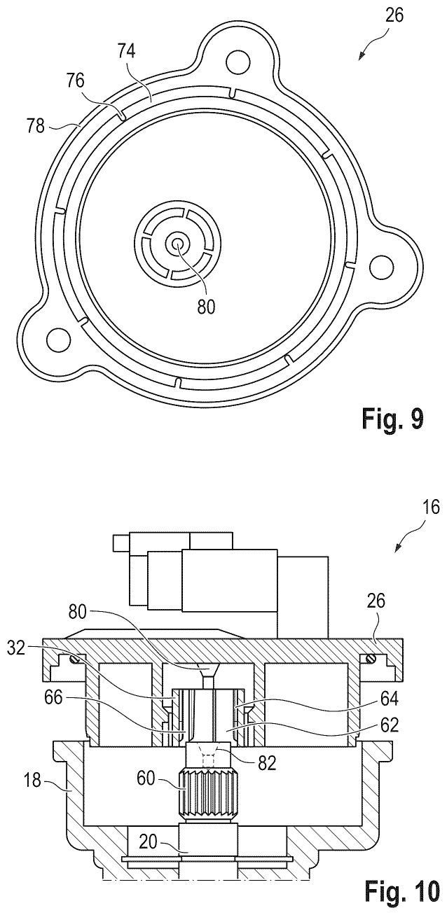

In order to prevent the seal 72 from falling out of the groove 74 during assembly, a plurality of clamping elements 76 are formed along the groove 74, as can be seen in FIG. 9.

The seal 72 is clamped in places by the clamping elements 76.

Alternatively, a self-adhesive seal or a liquid seal (also referred to as wet liquid seal) can be used. This contributes to a further reduction of the installation space in the radial direction, since the clamping elements 76 can be omitted. In addition, in the case of a self-adhesive seal, the screw lugs 24 can be omitted.

The seal 72 is shielded radially outwards by a collar 78 which projects from the housing cover 26 in the axial direction towards the housing 18 and projects axially beyond the seal. More specifically, the collar 78 axially overlaps the housing 18, so that the seal 72 is shielded from laterally impinging water jets.

FIGS. 7 and 9 also show a pin 80 which is integrally formed on the housing cover 26 and projects in the direction of the pinion 20.

When the sensor module 22 is mounted, the pin 80 projects into a centering recess 82 which is present on an end face of the pinion 20 directed towards the sensor module 22 (see FIG. 6).

The sensor module 22 and the pinion 20 are consequently aligned at two points, in particular at the pin 80 and at the sleeve-shaped portion 62 of the rotor 32.

Instead of a pin 80, an annularly projecting geometry can also be present.

The sensor module 22 is manufactured as a preassembled unit which can be handled individually.

In particular, the sensor module 22 is designed in such a way that it aligns radially during assembly on the housing 18 or on the pinion 20.

The assembly of the sensor module 22 will be described below in conjunction with FIGS. 10 to 13.

FIG. 10 illustrates the housing 18, the pinion 20 and the sensor module 22 at the beginning of an assembly. Specifically, the sensor module 22 is placed on the housing 18, with an approximate radial alignment taking place between the housing cover 26 and the housing 18 and between the rotor 32 and the pinion 20.

The rotor 32 overlaps an end portion of the pinion 20 which has no toothing.

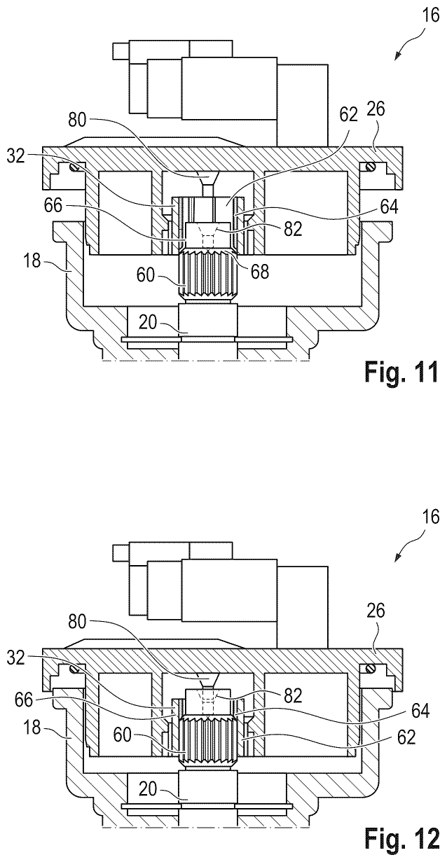

If the sensor module 22 is pushed further into the housing 18 starting from the position shown in FIG. 10, as is illustrated in FIG. 11, the rotor 32 encounters the conical bevel 68 of the toothing 60, as a result of which a more accurate radial alignment of the sensor module 22 takes place. The flexible portions 66 of the rotor 32 can deform to some extent in this step when the rotor 32 strikes the pinion 20 eccentrically. The elastic deformation which thereby occurs in the flexible portions 66 ensures in the following a defined alignment of the rotor 32 on the pinion 20.

When the sensor module 22 is pushed further into the housing 18, the ribs 64 of the rotor 32 engage the teeth 60 of the pinion 20, as is illustrated in FIG. 12. Due to the shape of the ribs 64 tapering towards the pinion 20 or the greater effective inner radius DI of the rotor 32 at the end of the rotor 32 directed towards the pinion 20, the introduction of the ribs 64 into the toothing 60 is simplified, wherein the clamping force between the rotor 32 and the pinion 20 increases with increasing overlap. In this way, the alignment of the rotor 32 on the pinion 20 is further improved.

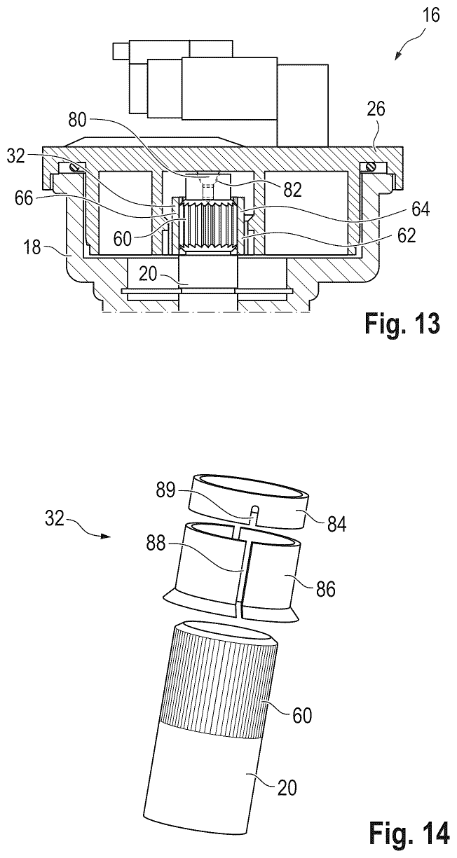

When the sensor module is pushed into its end position (see FIG. 13), the pin 80 engages in the centering recess 82, as a result of which the housing cover 26 is aligned with high accuracy on the pinion 20.

In the last step, the housing cover 26 is screwed to the housing 18, the seal 72 being compressed, so that a reliable sealing of the sensor module 22 to the outside is ensured.

As can be seen from the preceding description, the sensor module 22 is aligned via the rotor 32 during assembly with increasing accuracy on the pinion 20 and on the housing 18. In other words, the sensor module 22 is self-centering.

As a result, so-called “blind mounting” of the sensor module 22 on the housing 18 is possible.

Since blind mounting is possible, it is possible to manufacture the sensor module 22 as a prefabricated module which can be mounted as a unit on the housing 18.

FIGS. 14 to 16 show a pinion 20 with an alternative rotor 32 which can also be used in the sensor module 22 described above.

The rotor 32 according to FIGS. 14 to 16 differs from the rotor 32 described above in that the rotor 32 comprises a metallic component 84 and a plastic component 86 which are fixedly connected to one another in such a way that they cannot be detached from one another in a non-destructive manner.

The metallic component 84 is a ring.

The ring is of thin-walled design, i.e. it has a length which is several times greater than the wall thickness.

For example, the metallic component 84 is overmolded with the plastic forming the plastic component 86.

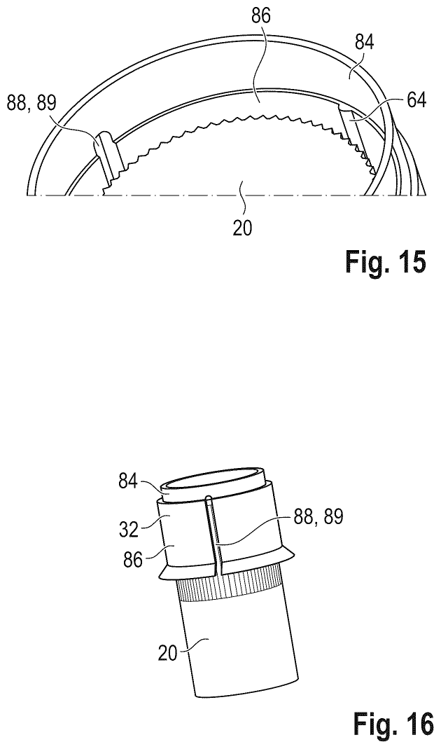

In the plastic component 86, a geometry for the rotationally fixed engagement of the rotor 32 with the pinion 20 is provided. This geometry is formed by ribs 64 (see FIG. 15), as has already been described in connection with the preceding embodiment.

Both the metallic component 84 and the plastic component 86 each have two slots 88, 89 extending in the axial direction.

Flexible portions 66 are provided in the rotor 32 by the slots 88, 89.

The slots 88 in the plastic component 86 start at a front end of the rotor 32, in particular at the end of the rotor 32 directed towards the pinion 20.

The slots 88, 89, viewed over the rotor 32 as a whole, are not continuous, so that the rotor 32 can be handled as a single component.

If the plastic component 86 is considered individually, the slots 88 are continuous. However, due to the firm connection with the metallic component 84, the individual segments of the plastic component 86 are held in position relative to one another.

The slots 88, 89 are arranged congruently to one another in the region in which the metallic component 84 overlaps with the plastic component.

Alternatively, more than two slots may also be present.

The external toothing 45, which is not illustrated in FIGS. 14 to 16 for the sake of simplicity, can likewise be injection-molded onto the metallic component 86.

The metallic component 84 is preferably made of a spring steel.

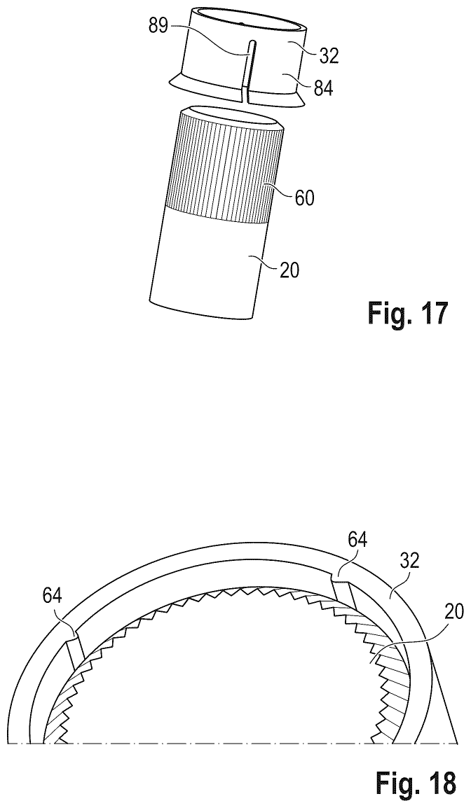

FIGS. 17 and 18 illustrate a further rotor 32 which can also be used in the sensor module 22.

The rotor 32 according to FIGS. 17 and 18 is similar to the rotor 32 according to FIGS. 14 to 16.

However, the geometry for the rotationally fixed engagement of the rotor 32 with the pinion 20 is provided in the metallic component 84 of the rotor 32.

The flexible portions 66 are likewise realized by two slots 89 which extend in the axial direction and are not continuous in the axial direction. This means that the slots 89 are shorter than the rotor 32.

The external toothing 45 in this embodiment can also be injection molded onto the metallic component 84.

Alternatively, it is also conceivable for the rotor 32, including the external toothing 45, to be made entirely of a metallic material, in particular of spring steel.

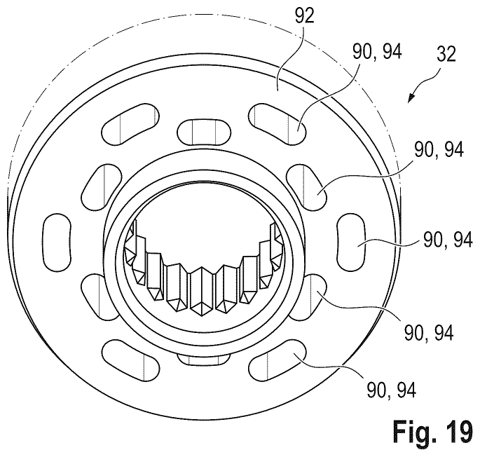

FIG. 19 illustrates a further rotor 32 which can likewise be used in the sensor module 22.

The rotor 32 is made of plastic according to the exemplary embodiment shown in FIG. 19, in particular the rotor 32 is an injection-molded part.

There are cavities 90 in the flexible portion 66 of the rotor 32. Due to the cavities 90, the rigidity of the rotor 32 in the flexible portion 66 is reduced, so that an elastic deformation in the flexible portion 66 is possible.

In practice, the rotor 32 has a circumferential, radially projecting collar 92 which has multiple openings 94 which pass through in the axial direction and form the cavities 90.

The openings 94 are preferably elongated holes, which are in particular curved.

1. A steering system (10) for a vehicle, in particular a steer-by-wire steering system, having a linearly displaceable rack (12), a drive portion of the rack (12), via which the rack (12) is moved during steering, and having a detection device (16), separate from the drive portion, for detecting a position of the rack (12), wherein the detection device (16) comprises a rotatable pinion (20) driven by the rack (12), which pinion has a toothing (21) in engagement with a toothing on the rack (12), and a rotor (32) which is in rotationally fixed engagement with the pinion (20), wherein the rotor (32) comprises at least one portion (66) which is flexible in the radial direction.

2. The steering system (10) according to claim 1, wherein the pinion (20) has a further toothing (60) which is axially spaced apart from the toothing (21) which is in engagement with the rack (12), wherein the rotor (32) is in engagement with the further toothing (60).

3. The steering system (10) according to claim 2, wherein the rotor (32) has a sleeve-shaped portion (62) on the inside of which there are axially extending ribs (64) which engage with the toothing (60) of the pinion (20), wherein the ribs (64) taper towards the pinion (20).

4. The steering system (10) according to claim 1, wherein the rotor (32) is produced from plastic and is surrounded by a separate stiffening element (70) in the region of the radially flexible portion (66).

5. The steering system (10) according to claim 1, wherein cavities (90) are present in the flexible portion (66) of the rotor (32).

6. The steering system (10) according to claim 5, wherein the rotor (32) has a circumferential radially projecting collar (92) having a plurality of axially through-openings (94) forming the cavities (90).

7. The steering system (10) according to claim 6, wherein the openings (94) are elongated holes which are in particular curved.

8. The steering system (10) according to claim 1, wherein the flexible portion (66) is provided by at least one slot (67, 88, 89) running in the axial direction in the rotor (32).

9. The steering system (10) according to claim 1, wherein the rotor (32) comprises at least one metallic component (84) or is formed from a metallic material.

10. The steering system (10) according to claim 9, wherein the metallic component (84) is formed from spring steel or wherein the metallic material is spring steel.

11. The steering system (10) according to claim 9, wherein the rotor (32) comprises a plastic component (86) which is firmly connected to the metallic component (84), wherein a geometry for the rotationally fixed engagement of the rotor (32) with the pinion (20) is provided in the plastic component (86).

12. The steering system (10) according to claim 11, wherein the metallic component (84) is overmolded with plastic.

13. The steering system (10) according to claim 11, wherein both the metallic component (84) and the plastic component (86) have a slot (88, 89).
